(19) United States
(12) Patent Application Publication
(10) Pub. No.: US 2009/0126026 A1
(43) Pub. Date: May 14, 2009

(54) METHOD, APPARATUS AND SYSTEM FOR MANAGING MALICIOUS-CODE SPREADING SITES USING SEARCH ENGINE

(76) Inventors: Min Sik KIM, Daejeon (KR); Jung Gil PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/102,381

(22) Filed: Apr. 14, 2008

(30) Foreign Application Priority Data
Nov. 8, 2007 (KR) 10-2007-0113972

(51) Int. Cl. G06F 7/04

(52) U.S. Cl. 726/27

(57) ABSTRACT

Provided is a method for enabling a user terminal to avoid exposure to a malicious code, by classifying web pages including a malicious code and blocking user access to the web pages including the malicious code when a user searches for a web page using a search engine. A method for managing malicious-code spreading sites using a search engine includes: analyzing a currently accessed web site to determine whether a malicious code is included in the web site; if the malicious code is included in the currently accessed web site, registering the web site as a malicious-code spreading site; and, if the web site registered as a malicious-code spreading site is included in a web-site search result from a search engine, blocking user access to the web site. Web pages including a malicious code are classified and user access to the web pages including the malicious code is blocked when a user searches for a web page using a search engine, thereby preventing a user terminal from being exposed to the malicious code.

### CROSS-REFERENCE TO RELATED APPLICATION

This application claims priority to and the benefit of Korean Patent Application No. 2007-113972, filed Nov. 8, 2007, the disclosure of which is incorporated herein by reference in its entirety.

### BACKGROUND

1. Field of the Invention

The present invention relates to a method for managing web sites, and more particularly, to a method for blocking user access to web sites including a malicious code.

2. Discussion of Related Art

Recent rapid development and widespread use of information systems and the Internet have increased importance of information distributed via Internet web sites. The information distributed via web sites is threatened by an exploit or malicious code, which may pose a threat to confidentiality, integrity, and availability of the information.

To prevent a malicious code from spreading via web sites, conventional web service providers have concentrated on operating security systems for their services.

However, if a user terminal accesses a web site through some other method than the web service provider that operates the security system, it may be infected with a fatal malicious code included in the web site.

Accordingly, there is a need for a method of blocking and managing web sites including a malicious code.

### SUMMARY OF THE INVENTION

The present invention is directed to a method for enabling a user terminal to avoid exposure to a malicious code, by classifying web pages including the malicious code and blocking user access to the web pages including the malicious code when a user searches for a web page using a search engine.

Additional objects and advantages of the present invention will be set forth in part in the description which follows and, in part, will be obvious from the description, or may be learned by practice of the invention.

One aspect of the present invention provides a method for managing malicious-code spreading sites using a search engine, the method comprising: analyzing a currently accessed web site to determine whether a malicious code is included in the web site; if the malicious code is included in the currently accessed web site, registering the web site as a malicious-code spreading site; and, if the web site registered as a malicious-code spreading site is included in a web-site search result from the search engine, blocking user access to the web site.

Another aspect of the present invention provides an apparatus for managing malicious-code spreading sites using a search engine, in which when a web site including a malicious code is included in a web-site search result from the search engine, user access to the web site is blocked, the apparatus comprising: a malicious code detector for receiving a URL of a web site likely to include the malicious code from a user terminal, accessing the web site via the received URL, and determining whether the malicious code is included in the web site; and a malicious-code spreading site manager for registering the web site as a malicious-code spreading site when it is determined that the malicious code is included in the web site and outputting the URL of the malicious-code spreading site to at least one search engine.

Still another aspect of the present invention provides a system for managing malicious-code spreading sites using a search engine, the system comprising: a search engine; a terminal capable of searching for web sites using the search engine; and a malicious-code spreading site managing apparatus for registering web sites including a malicious code as malicious-code spreading sites and managing the web sites including a malicious code, the apparatus being capable of communicating with the search engine and the terminal, wherein: the malicious-code spreading site managing apparatus comprises: a first malicious code detector for receiving from the terminal a URL of the web site likely to include a malicious code, and determining whether the malicious code is included in the web site; and a malicious-code spreading site manager for registering the web site as a malicious-code spreading site when it is determined that the malicious code is included in the web site and outputting the URL of the malicious-code spreading site to at least one search engine, and the search engine comprises: a storage unit for storing the URL of the web site; and a malicious-code spreading site blocker for blocking user access to the web site when the URL of the web site stored in the storage unit is included in a web-site search result from the search engine.

### BRIEF DESCRIPTION OF THE DRAWINGS

The above and other features and advantages of the present invention will become more apparent to those of ordinary skill in the art by describing in detail preferred exemplary embodiments thereof with reference to the attached drawings in which:

FIG. 1 is a schematic diagram of a system for managing malicious-code spreading sites according to an exemplary embodiment of the present invention;

FIG. 2a is a block diagram of a terminal according to an exemplary embodiment of the present invention;

FIG. 2b is a block diagram of an apparatus for managing malicious-code spreading sites according to an exemplary embodiment of the present invention;

FIG. 2c is a block diagram of a search engine according to an exemplary embodiment of the present invention;

FIG. 3 is a flowchart illustrating a method for managing malicious-code spreading sites according to an exemplary embodiment of the present invention; and

FIG. 4 is a flowchart illustrating a method for updating malicious-code spreading sites according to an exemplary embodiment of the present invention.

### DETAILED DESCRIPTION OF EXEMPLARY EMBODIMENTS

Hereinafter, exemplary embodiments of the present invention will be described in detail. However, the present invention is not limited to the exemplary embodiments disclosed below, but can be implemented in various forms. Therefore, the following exemplary embodiments are described in order for this disclosure to be complete and enable to those of ordinary skill in the art to embody and practice the present invention.

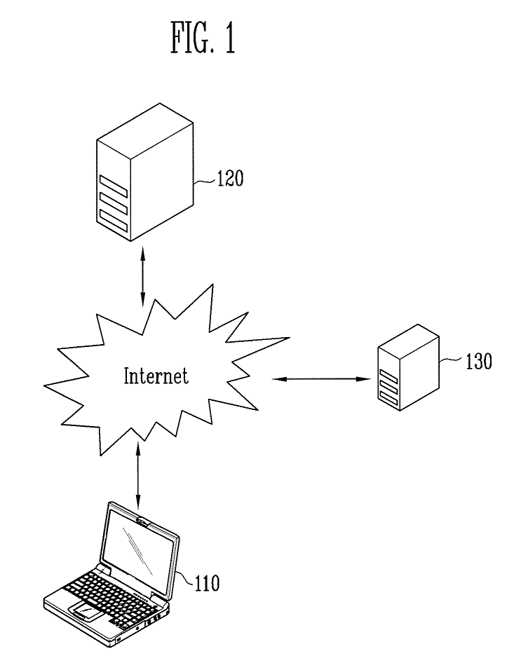

FIG. 1 is a schematic diagram of a system for managing malicious-code spreading sites using a search engine according to an exemplary embodiment of the present invention. Referring to FIG. 1, the system for managing malicious-code spreading sites according to an exemplary embodiment of the present invention comprises a terminal 110, a malicious-code spreading site managing apparatus 120, and a search engine 130. The system for managing malicious-code spreading sites according to an exemplary embodiment of the present invention will now be described in detail with reference to FIG. 1.

The terminal 110 according to an exemplary embodiment of the present invention may be any one of various electronic devices capable of accessing web sites via the Internet, including computers, mobile telephones, personal digital assistants (PDAs), and the like. When accessing the web site and determining that the web site is likely to include a malicious code, the terminal 110 outputs a Uniform Resource Locator (URL) of the web site to the malicious-code spreading site managing apparatus 120. Here, the web site is determined to be likely to include a malicious code when a processing speed of the terminal 110 becomes lower or an unsolicited program is executed.

The URL may be automatically output by software installed in the terminal 110 or manually by a user when the terminal is likely to be infected with a malicious code.

The malicious-code spreading site managing apparatus 120 according to an exemplary embodiment of the present invention accesses the web site likely to include a malicious code using its URL received from the terminal 110, and determines whether the malicious code is included in the web site. If the malicious code is included in the web site, the malicious-code spreading site managing apparatus 120 outputs the URL of the web site to the search engine 130. The malicious-code spreading site managing apparatus 120 may determine whether the malicious code is included in the web site by remotely accessing the web site and checking for symptoms or by using a program such as a vaccine program.

The search engine 130 according to an exemplary embodiment of the present invention stores the URL of the web site received from the malicious-code spreading site managing apparatus 120. If the stored URL is included in a web-site search result, the search engine 130 alerts the user or omits the URL when outputting the web-site search result. This blocks user access to the web site including the malicious code and protects the terminal 110 from the malicious code.

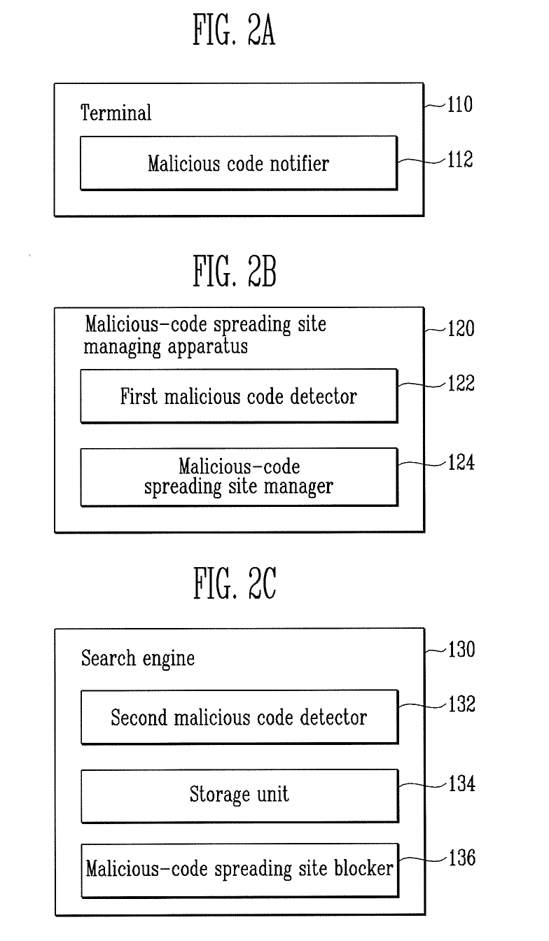

The system for managing malicious-code spreading sites using a search engine according to an exemplary embodiment of the present invention will be described below in greater detail with reference to FIG. 2.

FIG. 2a is a block diagram of the terminal 110 according to an exemplary embodiment of the present invention. Referring to FIG. 2a, the terminal 110 according to an exemplary embodiment of the present invention includes a malicious code notifier 112. The terminal 110 according to an exemplary embodiment of the present invention will now be described in greater detail with reference to FIG. 2a.

The malicious code notifier 112 according to an exemplary embodiment of the present invention analyzes a web site currently accessed by the terminal 110 to determine whether the malicious code is included in the web site. If it is determined that the malicious code is included in the currently accessed web site, the malicious code notifier 112 outputs a URL of the web site to the malicious-code spreading site managing apparatus 120.

If the malicious code is likely to be included in the currently accessed web page, the malicious code notifier 112 according to an exemplary embodiment of the present invention may also output the URL of the currently accessed web page to the malicious-code spreading site managing apparatus 120 in response to an instruction from the user.

Meanwhile, the terminal 100 according to an exemplary embodiment of the present invention may include a key input unit (not shown) for receiving the instruction from the user, and a display unit (not shown) for displaying the web-site search result.

FIG. 2b is a block diagram of the malicious-code spreading site managing apparatus 120 according to an exemplary embodiment of the present invention. Referring to FIG. 2b, the malicious-code spreading site managing apparatus 120 according to an exemplary embodiment of the present invention comprises a first malicious code detector 122, and a malicious-code spreading site manager 124. The malicious-code spreading site managing apparatus 120 according to an exemplary embodiment of the present invention will now be described in detail with reference to FIG. 2b.

The first malicious code detector 122 according to an exemplary embodiment of the present invention receives the URL of the web site likely to include a malicious code from the terminal 110, accesses the web site via the received URL, determines whether the malicious code is included in the web site, and outputs the determination result to the malicious-code spreading site manager 124.

Also, the first malicious code detector 122 according to an exemplary embodiment of the present invention periodically checks web sites registered as malicious-code spreading sites to determine whether or not the malicious code is still included in the site. The first malicious code detector 122 outputs the determination result to the malicious-code spreading site manager 124.

When the first malicious code detector 122 determines that the malicious code is included in the web site, the malicious-code spreading site manager 124 according to an exemplary embodiment of the present invention registers and stores the web site as a malicious-code spreading site and outputs the URL of the malicious-code spreading site to the search engine 130.

When the first malicious code detector 122 periodically checks the web site registered as a malicious-code spreading site and determines that the malicious code is no longer included in the registered web site, the malicious-code spreading site manager 124 according to an exemplary embodiment of the present invention unregisters the web site and outputs the URL of the unregistered web site to the search engine 130. Alternatively, the malicious-code spreading site manager 124 according to an exemplary embodiment of the present invention may produce a malicious-code spreading site list, update the malicious-code spreading site list every check, and output the updated malicious-code spreading site list to the search engine 130, instead of outputting the URL of the unregistered web site to the search engine.

FIG. 2c is a block diagram of the search engine 130 according to an exemplary embodiment of the present invention. Referring to FIG. 2c, the search engine 130 according to an exemplary embodiment of the present invention comprises a second malicious code detector 132, a storage unit 134, and a malicious-code spreading site blocker 136. The search engine 130 according to an exemplary embodiment of the present invention will now be described in detail with reference to FIG. 2c.

The second malicious code detector 132 according to an exemplary embodiment of the present invention accesses the web page via the URL received from the malicious-code spreading site managing apparatus 120 and determines whether a malicious code is included in the web site. In this case, the second malicious code detector 132 may use a different algorithm from the first malicious code detector 122 of the malicious-code spreading site managing apparatus 120 to determine whether the malicious code is included, to provide an additional guarantee of security that the web site is registered as the malicious-code spreading site. The second malicious code detector 132 according to an exemplary embodiment of the present invention may be unnecessary depending on construction of the system.

The storage unit 134 according to an exemplary embodiment of the present invention stores the URL of the web site including the malicious code received from the malicious-code spreading site managing apparatus 120 or the second malicious code detector 132.

When the URL of the web site stored in the storage unit 134 is included in the web-site search result, the malicious-code spreading site blocker 136 according to an exemplary embodiment of the present invention blocks user access to the web site.

That is, the malicious-code spreading site blocker 136 according to an exemplary embodiment of the present invention, when outputting the web-site search result, may omit information on the web site registered as the malicious-code spreading site.

Also, when outputting the web-site search result including information on the web site registered as the malicious-code spreading site, the malicious-code spreading site blocker 136 may output a message to notify the user that the web site is the malicious-code spreading site. Based on the message, the user may determine whether to access the web site registered as the malicious-code spreading site.

When outputting the web-site search result including the information on the web site registered as a malicious-code spreading site, the malicious-code spreading site blocker 136 may block user access to the web site by disabling a link to the web site.

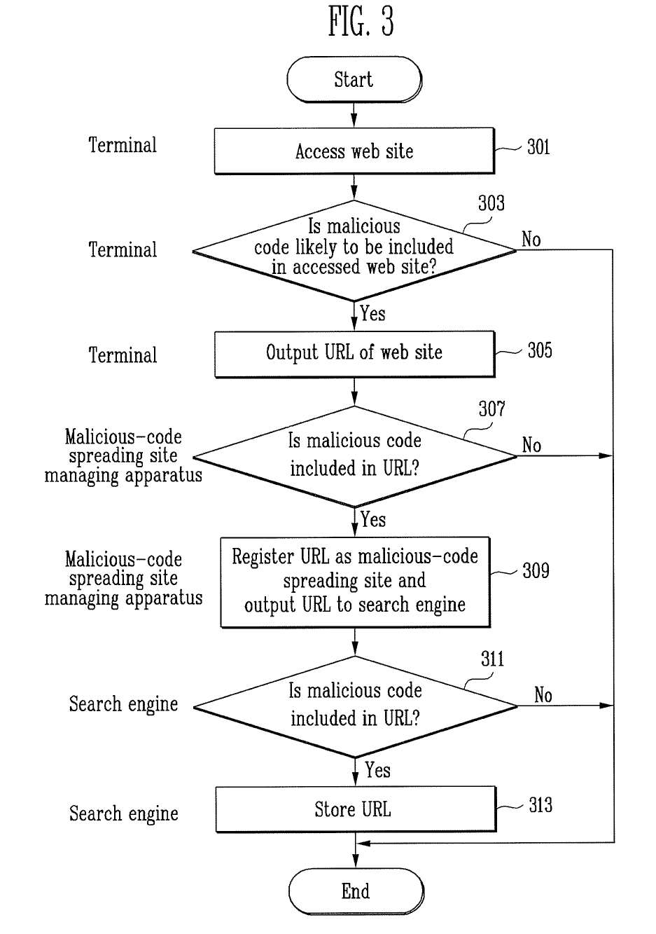

FIG. 3 is a flowchart illustrating a method for managing malicious-code spreading sites using a search engine according to an exemplary embodiment of the present invention. The method for managing malicious-code spreading sites according to an exemplary embodiment of the present invention will now be described with reference to FIG. 3.

In step 303, the malicious code notifier 112 of the terminal 110 according to an exemplary embodiment of the present invention determines whether a malicious code is likely to be included in a web site that the terminal 110 accesses in step 301.

If it is determined that the malicious code is likely to be included in the web site, the malicious code notifier 112 of the terminal 110 according to an exemplary embodiment of the present invention outputs a URL of the web site to the malicious-code spreading site managing apparatus 120 in step 305.

In step 307, the first malicious code detector 122 of the malicious-code spreading site managing apparatus 120 according to an exemplary embodiment of the present invention receives the URL of the web site likely to include a malicious code from the terminal 110, accesses the web site via the received URL, and determines whether the malicious code is included in the web site.

In step 309, if the first malicious code detector 122 determines that the malicious code is included in the web site, the malicious-code spreading site manager 124 of the malicious-code spreading site managing apparatus 120 according to an exemplary embodiment of the present invention registers the web site as a malicious-code spreading site and outputs the URL of the registered web site to the search engine 130.

In step 311, the second malicious code detector 132 of the search engine 130 according to an exemplary embodiment of the present invention accesses the web page via the URL received from the malicious-code spreading site manager 124 of the malicious-code spreading site managing apparatus 120, and determines whether the malicious code is included in the web site.

In step 313, if the second malicious code detector 132 determines that the malicious code is included in the web site, the malicious-code spreading site blocker 136 of the search engine 130 according to an exemplary embodiment of the present invention stores the URL of the web site in the storage unit 134.

Thereafter, if the URL stored in the storage unit 134 is included in the web-site search result from the search engine 130, the malicious-code spreading site blocker 136 does not output the URL information, outputs the URL information with an alert message indicating that the site is a malicious-code spreading site, or outputs the URL information having no link to the web site, thus protecting the user terminal 110 from the malicious code.

Meanwhile, the step 311 may be unnecessary according to constructions of the system. In this case, the malicious-code spreading site blocker 136 stores, in the storage unit 134, the URL of the web site determined as including a malicious-code by the malicious-code spreading site manager 124 of the malicious-code spreading site managing apparatus 120.

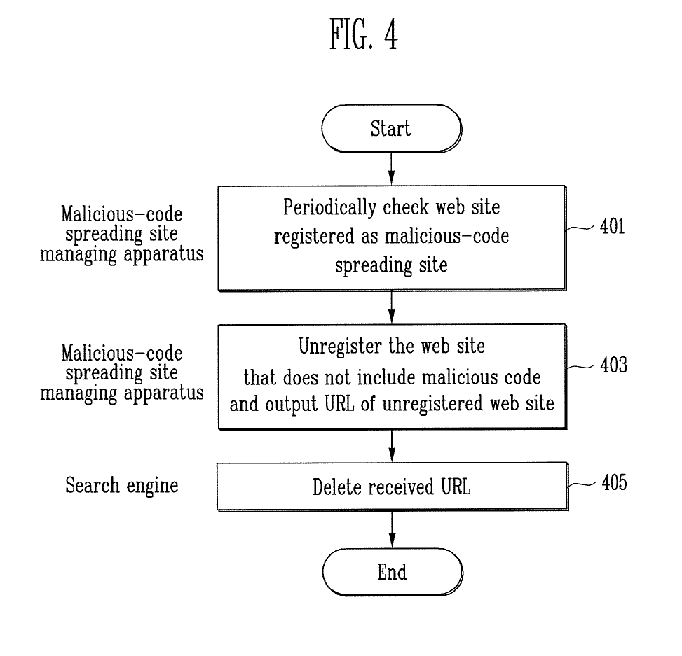

FIG. 4 is a flowchart illustrating a method for updating a malicious-code spreading site according to an exemplary embodiment of the present invention. The method for updating a malicious-code spreading site according to an exemplary embodiment of the present invention will now be described with reference to FIG. 4.

In step 401, the first malicious code detector 122 of the malicious-code spreading site managing apparatus 120 according to an exemplary embodiment of the present invention periodically checks the web site registered as the malicious-code spreading site to determine whether or not the malicious code is still included in the web site.

In step 403, when it is determined in step 401 that the malicious code is no longer included in the web site registered as the malicious-code spreading site, the malicious-code spreading site manager 124 of the malicious-code spreading site managing apparatus 120 according to an exemplary embodiment of the present invention unregisters the web site, and outputs the URL of the unregistered web site to the search engine 130.

In step 405, the malicious-code spreading site blocker 136 of the search engine 130 according to an exemplary embodiment of the present invention deletes, from the storage unit 134, the URL of the unregistered web site.

Meanwhile, in step 403, the malicious-code spreading site manager 124 according to an exemplary embodiment of the present invention may produce a malicious-code spreading site list, update the malicious-code spreading site list every check, and output the updated malicious-code spreading site list to the search engine 130, instead of outputting the URL of the unregistered web site to the search engine.

In this case, the search engine 130 stores the malicious-code spreading site list received from the malicious-code spreading site manager 124, in the storage unit 134.

As described above, the present invention comprises classifying web pages including a malicious code and blocking user access to the web pages including the malicious code when a user searches for a web page using a search engine, so that a user terminal is not exposed to the malicious code.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A method for managing malicious-code spreading sites using a search engine, the method comprising:
analyzing a currently accessed web site to determine whether a malicious code is included in the web site;
if the malicious code is included in the currently accessed web site, registering the web site as a malicious-code spreading site; and
if the web site registered as a malicious-code spreading site is included in a web-site search result from the search engine, blocking user access to the web site.

2. The method of claim 1, wherein the blocking of user access includes outputting the web-site search result containing no information on the web site registered as a malicious-code spreading site.

3. The method of claim 1, wherein the blocking of user access includes outputting the web-site search result containing information on the web site registered as a malicious-code spreading site, together with an indication that the web site is a malicious-code spreading site.

4. The method of claim 3, wherein the blocking of user access further includes accessing the malicious-code spreading site in response to a user's selection.

5. The method of claim 1, wherein the blocking of user access includes outputting the web-site search result containing information on the web site registered as a malicious-code spreading site and having no link to the web site.

6. The method of claim 1, further comprising periodically checking the web site registered as a malicious-code spreading site, and unregistering the web site when a malicious code is no longer included in the web site.

7. An apparatus for managing malicious-code spreading sites using a search engine, in which when a web site including a malicious code is included in a web-site search result from the search engine, user access to the web site is blocked, the apparatus comprising:
a malicious code detector for receiving a URL of a web site likely to include the malicious code from a user terminal, accessing the web site via the received URL, and determining whether the malicious code is included in the web site; and
a malicious-code spreading site manager for registering the web site as a malicious-code spreading site when it is determined that the malicious code is included in the web site, and outputting the URL of the malicious-code spreading site to at least one search engine.

8. The apparatus of claim 7, wherein the malicious code detector periodically checks the web site registered as a malicious-code spreading site, and
when it is checked that a malicious code is not included in the web site registered as a malicious-code spreading site, the malicious-code spreading site manager unregisters the web site and outputs the URL of the unregistered web site to the at least one search engine.

9. The apparatus of claim 7, wherein the malicious code detector periodically checks the web site registered as a malicious-code spreading site, and
the malicious-code spreading site manager produces a list of web sites registered as malicious-code spreading sites, updates the list based on the check result, and outputs the updated list to the at least one search engine.

10. A system for managing malicious-code spreading sites using a search engine, the system comprising:
at least one search engine;
a terminal capable of searching for web sites using the search engine; and
a malicious-code spreading site managing apparatus for registering and managing web sites including a malicious code as malicious-code spreading sites, the apparatus being capable of communicating with the search engine and the terminal,
wherein the malicious-code spreading site managing apparatus comprises:
a first malicious code detector for receiving, from the terminal, a URL of the web site likely to include a malicious code, and determining whether the malicious code is included in the web site; and
a malicious-code spreading site manager for registering the web site as a malicious-code spreading site when it is determined that the malicious code is included in the web site, and outputting the URL of the malicious-code spreading site to at least one the search engine, and
the search engine comprises:
a storage unit for storing the URL of the web site; and
a malicious-code spreading site blocker for blocking user access to the web site when the URL of the web site stored in the storage unit is included in a web-site search result from the search engine.

11. The system of claim 10, wherein the terminal comprises a malicious code notifier for analyzing a currently accessed web page, and outputting a URL of the currently accessed web page to the malicious-code spreading site managing apparatus when the malicious code is likely to be included in the web page.

12. The system of claim 11, wherein the malicious code notifier receives an input from the user indicating that the malicious code is likely to be included in the currently accessed web page, and outputs the URL of the currently accessed web page to the malicious-code spreading site managing apparatus in response to the user's input.

13. The system of claim 10, wherein the search engine server further comprises a second malicious code detector for accessing the web site via the URL of the malicious-code spreading site received from the malicious-code spreading site manager, and determining whether the malicious code is included in the web site, and
the malicious-code spreading site blocker further comprises a second malicious code detector for storing the URL of the web site in the storage unit when the second malicious code detector determines that the malicious code is included in the web site.

14. The system of claim 10, wherein the first malicious code detector periodically checks the web site registered as a malicious-code spreading site, and
when it is checked that a malicious code is not included in the web site registered as a malicious-code spreading site, the malicious-code spreading site manager unregisters the web site and outputs the URL of the unregistered web site to the at least one search engine.

15. The system of claim 10, wherein the first malicious code detector periodically checks the web site registered as a malicious-code spreading site, and
the malicious-code spreading site manager produces a list of web sites registered as malicious-code spreading sites, updates the list based on the check result, and outputs the updated list to the at least one search engine.

16. The system of claim 10, wherein the malicious-code spreading site blocker outputs the web-site search result containing no information on the web site registered as a malicious-code spreading site.

17. The system of claim 10, wherein the malicious-code spreading site blocker outputs the web-site search result containing information on the web site registered as a malicious-code spreading site, together with an indication that the web site is a malicious-code spreading site.

18. The system of claim 17, wherein the malicious-code spreading site blocker accesses the malicious-code spreading site in response to a user's selection.

19. The system of claim 10, wherein the malicious-code spreading site manager outputs the web-site search result containing information on the web site registered as a malicious-code spreading site and having no link to the web site.
